(19) United States
(12) Patent Application Publication
(10) Pub. No.: US 2008/0028878 A1
(43) Pub. Date: Feb. 7, 2008

(54) Lifting Device having Double Screw Rods

(76) Inventor: Chia-Jung Wang, Xindian City (TW)

Correspondence Address: HDSL, 4331 STEVENS BATTLE LANE, FAIRFAX, VA, 22033, US

(21) Appl. No.: 11/462,994

(22) Filed: Aug. 7, 2006

(51) Int. Cl. F16H 27/02

(52) U.S. Cl. 74/89.35

(57) ABSTRACT

A lifting device having double screw rods is respectively connected on first, second and third sliding units interconnected to one another, which includes a driving means, a first transmission means and a second transmission means. The driving means is fixedly connected to the bottom end of the first sliding unit. The first transmission means includes a screw rod connected to the driving means and a telescopic tube assembly linearly movable relative to the screw rod. The screw rod is driven by the driving means. The other end of the telescopic assembly is fixedly connected to the top end of the second sliding unit. The second transmission means is provided at one side of the first transmission means and parallel thereto. Further, the second transmission means comprises a sleeve driven by the first transmission means to rotate and a screw rod threadedly connected to the sleeve. One end of the screw rod is fixedly connected to bottom end of the third transmission means. With the above arrangement, the whole structure is simplified to save the expense of machining and heat-treating each member, thereby to efficiently reduce the cost.

### BACKGROUND OF THE INVENTION

1. Field of the Invention

The present invention relates to a lifting device having double screw rods, and in particular to a lifting device mounted in the electric table or electric bed.

2. Description of Prior Art

Conventionally, a lifting device is provided within a two-stage sliding unit and then connected to an electric table or electric bed, so that the higher or lower position of the electric table or electric bed can be adjusted. Since the total length of the extension of the lifting device does not exceed the sum of two sliding units and the total length of the retraction is not lower than the length of any one longer sliding unit, the extension and retraction stroke that is possibly achieved is limited and thus cannot satisfy the requirement for a larger adjusting space in the existing market. Therefore, there is proposed a multiple-stage (such as three-stage or four-stage) sliding unit. In addition to have a larger amount of extension and a shorter amount of retraction than those of the two-stage sliding unit, the moving speed of extension or retraction of the multiple-stage sliding unit is also faster. Thus, it is an important issue for those skilled in this art to provide a lifting device having multiple-stage sliding units.

The conventional lifting device mainly comprises a driving means, a first transmission means and a second transmission means. The first transmission means comprises a cylindrical screw rod and a nut driven by the driving means. The inside and outside of the cylindrical screw rod are provided with inner and outer threads, respectively. The outer thread is threadedly connected to the nut. The second transmission means and the first transmission means are provided in series. The second transmission means has a pillared screw rod threadedly connected with the inner thread of the cylindrical screw rod, so that the cylindrical screw rod can move linearly relative to the nut and the pillared screw rod at the same time. Further, with the transmission of the driving means, each sliding unit can slide relative to each other.

However, in practical use, the conventional lifting device having screw rods has still some problems as follows. Since the primary members such as the cylindrical screw rod and the pillared screw rod are manufactured separately, those elements cannot be interchangeable, so that the total cost of the elements cannot be reduced efficiently. Further, the inside and outside of the cylindrical screw rod are provided with threads, the machining process is thus very complicated and difficult. Also, after the machining process, it is not easy to perform the heat treatment to obtain a good surface hardness. As a result, it is very fast to generate wear between the inner threads of the cylindrical screw rod and the pillared screw rod, causing the increase in the subsequent cost for maintenance and inconvenience in use.

In view of the above, the inventor proposes the present invention to overcome the above problems based on his expert experiences and deliberate researches.

### SUMMARY OF THE INVENTION

The present invention is to provide a lifting device having double screw rods, in which the parallel arrangement of each screw rod makes it interchangeable, so that the whole structure is simplified to save the expense of machining and heat-treating each member, thereby to efficiently reduce the cost.

the present invention provides a lifting device having double screw rods. The lifting device is respectively connected on first, second and third sliding units which are interconnected to one another. The lifting device can control the relative sliding movements among each sliding unit, which comprises a driving means, a first transmission means and a second transmission means. The driving means is fixedly connected to the bottom end of the first sliding unit. The first transmission means comprises a screw rod connected to the driving means and a telescopic tube assembly threadedly connected to the screw rod and linearly movable relative to the screw rod. The screw rod is driven by the driving means. The other end of the telescopic assembly is fixedly connected to the top end of the second sliding unit. The second transmission means is provided at one side of the first transmission means and parallel thereto. Further, the second transmission means comprises a sleeve driven by the first transmission means to rotate and another screw rod threadedly connected to the sleeve. One end of the screw rod is fixedly connected to bottom end of the third transmission means. The driving means simultaneously drives the second and third transmission means to protrude or retract relative to the first sliding means.

The present invention provides a lifting device having double screw rods. The lifting device is respectively connected on first, second and third sliding units which are interconnected to one another. The lifting device can control the relative sliding movements among each sliding unit, which comprises a driving means, a first transmission means and a second transmission means. The driving means is fixedly connected to the bottom end of the first sliding unit. The first transmission means comprises a screw rod connected to the driving means and a telescopic tube assembly threadedly connected to the screw rod and linearly movable relative to the screw rod. The screw rod is driven by the driving means. The other end of the telescopic assembly is fixedly connected to the top end of the second sliding unit. The second transmission means is provided at one side of the first transmission means and parallel thereto. Further, the second transmission means comprises a sleeve driven by the driving means to rotate and another screw rod threadedly connected to the sleeve. One end of the screw rod is fixedly connected to bottom end of the third transmission means. The driving means simultaneously drives the second and third transmission means to protrude or retract relative to the first sliding means.

### BRIEF DESCRIPTION OF THE DRAWINGS

FIG. 1 is an assembled cross-sectional view of the first embodiment of the present invention;

FIG. 2 is a partially enlarged cross-sectional view of the present invention;

FIG. 3 is a cross-sectional along the line 3-3 in FIG. 2;

FIG. 4 is a cross-sectional along the line 4-4 in FIG. 2;

FIG. 5 is a cross-sectional view showing the operating state of the present invention; and

FIG. 6 is a partially assembled cross-sectional view of another embodiment of the present invention.

### DETAILED DESCRIPTION OF THE INVENTION

The characteristics and the technical contents of the present invention will be described with reference to the following detailed description and the accompanying drawings. However, it should be understood that the drawings are illustrative but not used to limit the scope of the present invention.

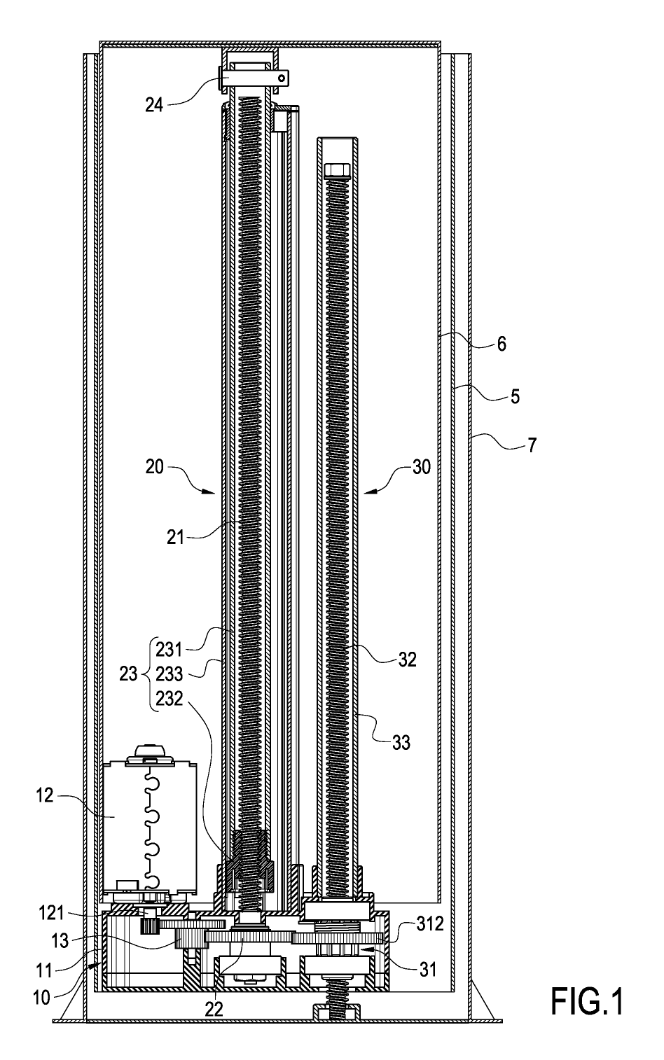

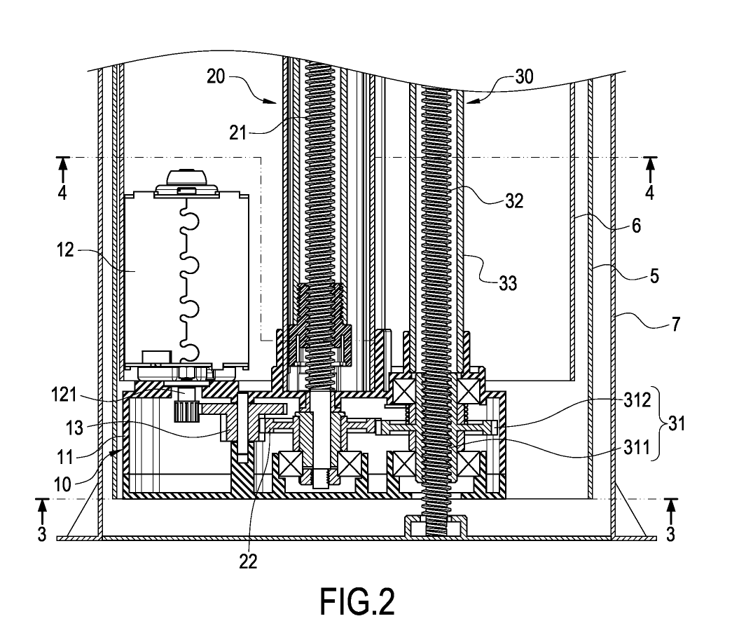

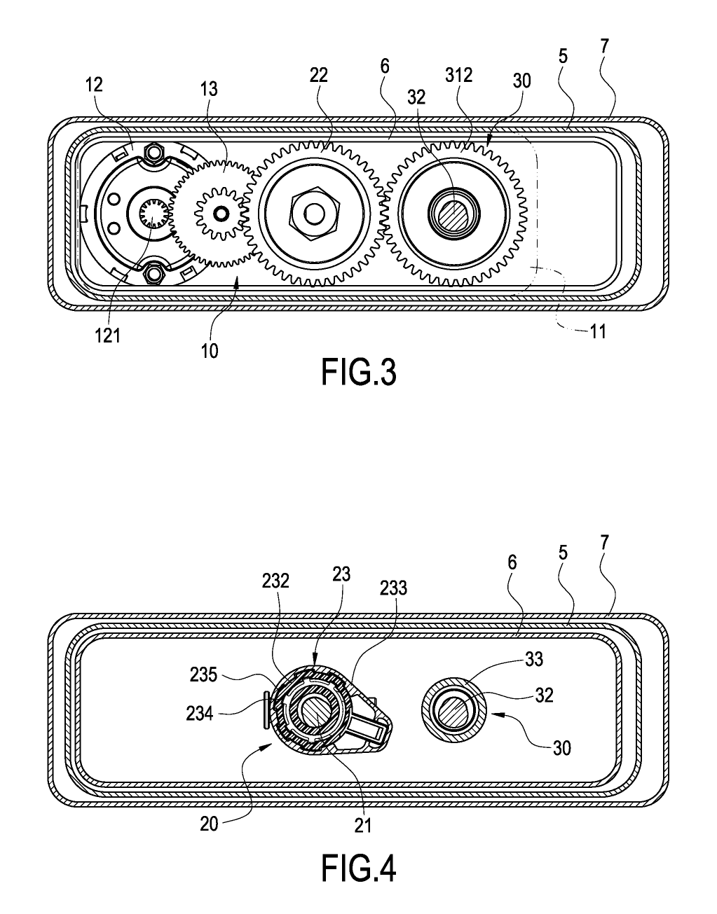

FIG. 1 is an assembled cross-sectional view of the first embodiment of the present invention. FIG. 2 is a partially enlarged cross-sectional view of the present invention. FIG. 3 is a cross-sectional along the line 3-3 in FIG. 2. FIG. 4 is a cross-sectional along the line 4-4 in FIG. 2. The present invention provides a lifting device having double screw rods. The lifting device is connected respectively to a first sliding unit 5, a second sliding unit 6 and a third sliding unit 7 which are interconnected with each other so as to control the relative sliding movements among each sliding unit 5, 6, 7. Each sliding unit 5, 6, 7 can be formed into a hollow rectangular tube with different sizes. The lifting device comprises a driving means 10, a first transmission means 20 and a second transmission means 30.

The driving means 10 is fixedly connected to the bottom end of the first sliding unit 5, and it comprises a box-shaped base body 11 fixed on the bottom end of the first sliding unit 5 and a motor 12 connected to the top plate of the base body 11. A transmission shaft 121 protrudes outwardly from the center of the motor 12. The transmission shaft 121 is connected to a spur gear. The interior of the base body 11 is provided with an idle pulley 13 brought into engagement and transmission with the spur gear.

The first transmission means 20 comprises a screw rod 21, a first gear 22 and a telescopic tube assembly 23. The screw rod 21 is provided to be parallel to the transmission shaft 121 of the motor 12. The bottom end of the screw rod penetrates into the base body 11 of the driving means 10 and is fixed into the base body 12 via a bearing. The first gear 22 is connected to the bottom end of the screw rod 21 to rotate with the screw rod 21. The first gear 22 is driven by the idle pulley 13 of the driving means 10. The telescopic tube assembly 23 comprises a telescopic tube 231, a nut 232 fixedly connected to the bottom end of the telescopic tube 231, and an outer tube 233 connected to the outside of the telescopic tube 231. The nut 232 is threadedly connected on the screw rod 21 and circumferentially provided on its outer periphery with a plurality of guiding blocks 234 at intervals (FIG. 4). Further, in the interior of the outer tube 233, a plurality of guiding grooves 235 are provided for cooperating with the guiding blocks 234, so that the telescopic tube 231 can be linearly moved relative to the screw rod 21. The top end of the telescopic tube 231 is fixedly connected to the top end of the second sliding unit 6 via an insertion pin 24.

The second transmission means 30 is provided at one side of the first transmission means 20 and is parallel thereto. The second transmission means 30 comprises a sleeve 31, a screw rod 32 and a tube 33. The sleeve 31 is a cylinder and fixed into the base body 11 via a bearing. The interior of the sleeve 31 has an inner thread 311 for threadedly connecting to the screw rod 32, and the exterior thereof is formed with a second gear 312 for rotatably engaging with the first gear 22. In this way, the sleeve 31 can be driven to rotate by the first transmission means 20. The bottom end of the screw rod 32 is fixedly connected to the bottom end of the third sliding unit 7. The bottom end of the tube 33 is inserted to the base body 11 and connected to the outside of the screw rod 32.

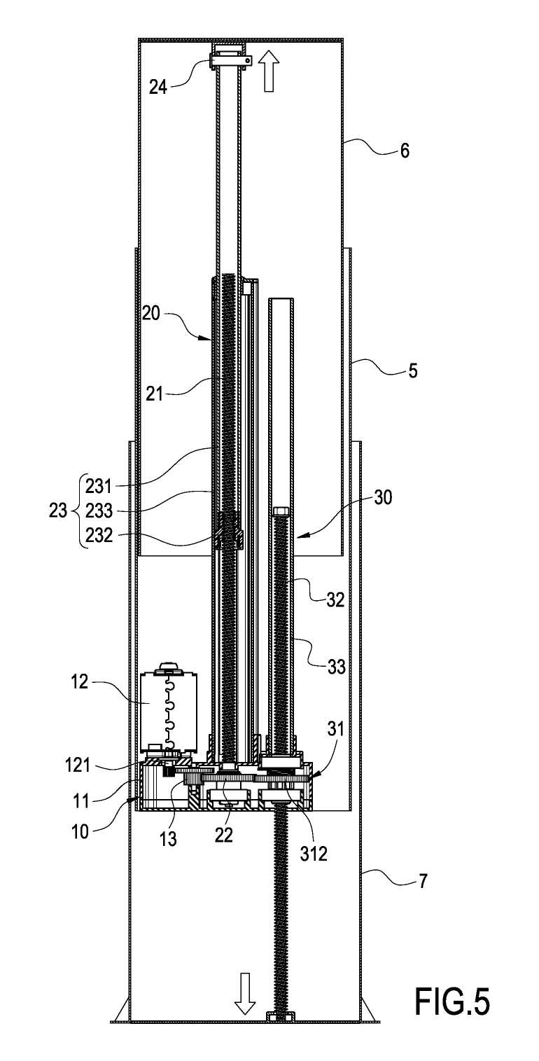

With reference to FIG. 5, it is a cross-sectional view showing the operating state of the present invention. The lifting device of the present invention can be mounted on an electric table or an electric bed. In use, the rotation of the transmission shaft 121 of the motor 12 simultaneously drives the idle pulley 13 to rotate accordingly. Then, the idle pulley 13 drives the first gear 22 and the screw rod 21 to rotate together. The screw rod 21 can make the telescopic tube assembly 23 threadedly connected thereon to linearly protrude, so that the second sliding unit 6 fixedly connected to the distal end of the telescopic tube 231 can protrude relative to the first sliding unit 5. Further, the first gear 22 drives the second gear 312 to rotate, so that the screw rod 32 can be linearly moved relative to the sleeve 31. Since the bottom end of the screw rod 32 is fixedly connected on the third sliding unit 7, it drives the third sliding unit 7 to protrude relative to the first sliding unit 5. On the contrary, with the reverse rotation of the transmission shaft 121 of the motor 11, the second sliding unit 6 and the third sliding unit 7 can be driven to retract relative to the first sliding unit 5.

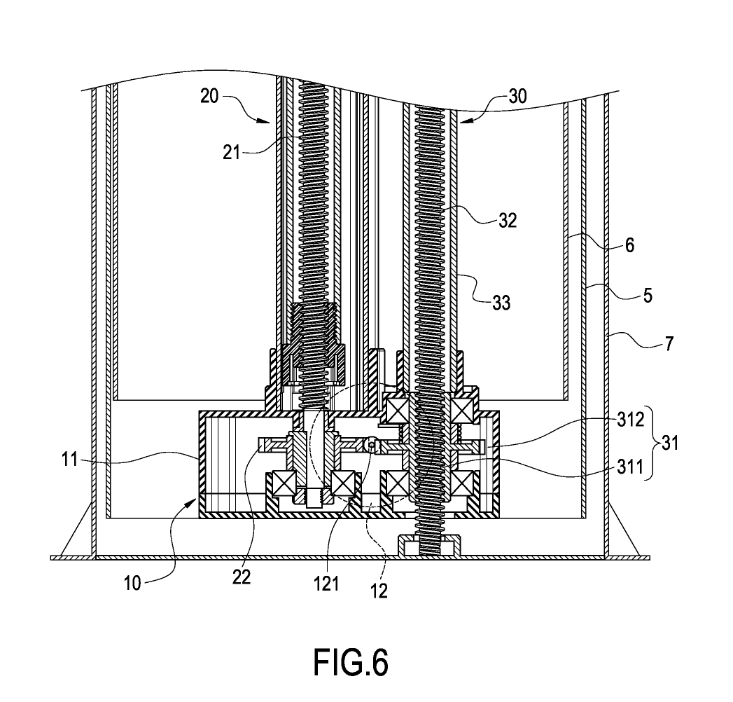

With reference to FIG. 6, it shows a partially assembled cross-sectional view of another embodiment of the present invention. In addition to the aspect shown in the above embodiment, the driving means 10 of the present invention allows the motor 12 to be fixedly connected to the side plate of the base body 11 and the transmission shaft 121 to penetrate into the base body 11 in the direction perpendicular to each screw rod 21, 32. With such arrangement, the first gear 22 and the second gear 312 of the sleeve 31 can be simultaneously driven to rotate. The transmission shaft is worm, and the first gear 22 and the second gear 312 are worm gears for rotatably cooperating with the worm. The first gear 22 rotates with the screw rod 21, thereby to drive the telescopic tube 231 and the nut 232 to linearly move relative thereto. As a result, the second sliding unit 6 fixedly connected to the distal end of the telescopic tube 231 protrudes relative to the first sliding unit 5. Further, the rotation of the sleeve 31 can drive the screw rod 32 to linearly move relative thereto. Also, since the bottom end of the screw rod 32 is fixedly connected onto the third sliding unit 7, it can drive the third sliding unit 7 to protrude relative to the first sliding unit 5. As a result, the lifting device can be partially changed according to the requirements of various products so as to increase its field of application.

According to the above, the lifting device having double screw rods of the present invention indeed has industrial applicability, novelty and inventive steps. Further, since the construction of the present invention has not been used in any products of the same kind or in public or published prior to applying for patent. Therefore, the present invention completely conforms to the requirements for a utility model patent.

Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A lifting device having double screw rods, the lifting device connected respectively to a first, a second and a third sliding units interconnected with each other so as to control relative sliding movements among each sliding unit, the lifting device comprising:
a driving means fixedly connected to a bottom end of the first sliding unit;
a first transmission means comprising a first screw rod connected to the driving means and a telescopic tube assembly threadedly connected to the first screw rod and linearly movable relative to the first screw rod, the first screw rod driven by the driving means, the other end of the telescopic assembly fixedly connected to the top end of the second sliding unit; and
a second transmission means provided at one side of the first transmission means and parallel thereto, the second transmission means comprising a sleeve driven by the first transmission means to rotate and a second screw rod threadedly connected to the sleeve, one end of the second screw rod fixedly connected to a bottom end of the third transmission means,
wherein the driving means simultaneously drives the second and third transmission means to protrude or retract relative to the first sliding means.

2. The lifting device having double screw rods according to claim 1, wherein the driving means further comprises a base body fixed on the bottom end of the first sliding unit and a motor connected to one side of the base body, a transmission shaft protrudes from center of the motor, the first transmission means further comprises a first gear fixedly connected to the first screw rod, an exterior of the sleeve of the second transmission means is formed with a second gear, the transmission shaft is used to drive the first gear to rotate, and the first gear drives the second gear to rotate.

3. The lifting device having double screw rods according to claim 2, wherein the transmission shaft of the motor is provided to be parallel to the first screw rod of the first transmission means.

4. The lifting device having double screw rods according to claim 2, wherein the driving means further comprises an idle pulley fixed in an interior of the base body and brought into rotatable engagement with the transmission shaft and the first gear respectively.

5. The lifting device having double screw rods according to claim 1, wherein the telescopic tube assembly of the first transmission means comprises a telescopic tube, a nut fixedly connected to one end of the telescopic tube, and an outer tube connected to outside of the telescopic tube, the nut is threadedly connected to the screw rod of the first transmission means, and the other end of the telescopic tube is fixedly connected to the top end of the second sliding unit.

6. The lifting device having double screw rods according to claim 5, wherein the nut is circumferentially provided on an outer periphery thereof with a plurality of guiding blocks at intervals, and in an interior of the outer tube, a plurality of guiding grooves are provided for cooperating with the guiding blocks to guide the relative movements.

7. A lifting device having double screw rods, the lifting device connected respectively to a first, a second and a third sliding units interconnected with each other so as to control relative sliding movements among each sliding unit, the lifting device comprising:
a driving means fixedly connected to a bottom end of the first sliding unit;
a first transmission means comprising a screw rod connected to the driving means and a telescopic tube assembly threadedly connected to a first screw rod and linearly movable relative to the first screw rod, the first screw rod driven by the driving means, the other end of the telescopic assembly fixedly connected to a top end of the second sliding unit; and
a second transmission means provided at one side of the first transmission means and parallel thereto, the second transmission means comprising a sleeve driven by the driving means to rotate and a second screw rod threadedly connected to the sleeve, one end of the second screw rod fixedly connected to bottom end of the third transmission means,
wherein the driving means simultaneously drives the second and third transmission means to protrude or retract relative to the first sliding means.

8. The lifting device having double screw rods according to claim 7, wherein the driving means comprises a base body fixed on the bottom end of the first sliding unit and a motor connected to the base body, a transmission shaft protrudes from the center of the motor, the first transmission means further comprises a first gear fixedly connected to the bottom end of the first screw rod, the exterior of the sleeve of the second transmission means is formed with a second gear, and the first gear and the second gear are simultaneously driven to rotate by the transmission shaft.

9. The lifting device having double screw rods according to claim 8, wherein the transmission shaft of the motor is provided to be perpendicular to the scrfirst ew rod of the first transmission means.

10. The lifting device having double screw rods according to claim 7, wherein the telescopic tube assembly of the first transmission means comprises a telescopic tube, a nut fixedly connected to one end of the telescopic tube, and an outer tube connected to the outside of the telescopic tube, the nut is threadedly connected to the first screw rod of the first transmission means, and the other end of the telescopic tube is fixedly connected to the top end of the second sliding unit.

11. The lifting device having double screw rods according to claim 10, wherein the nut is circumferentially provided on an outer periphery thereof with a plurality of guiding blocks at intervals, and in an interior of the outer tube, a plurality of guiding grooves are provided for cooperating with the guiding blocks to guide the relative movements.
